(19) United States
(12) Patent Application Publication
(10) Pub. No.: US 2018/0181920 A1
(43) Pub. Date: Jun. 28, 2018

(54) METHOD, SYSTEM AND NON-TRANSITORY COMPUTER-READABLE RECORDING MEDIUM FOR ASSISTING SCHEDULE MANAGEMENT

(71) Applicant: Konolabs, Inc., Seoul (KR)

(72) Inventors: Boa MIN, Seoul (KR); Dae Hoo KIM, Seoul (KR); Jung Hee RYU, Seoul (KR)

(73) Assignee: Konolabs, Inc., Seoul (KR)

(21) Appl. No.: 15/848,361

(22) Filed: Dec. 20, 2017

(30) Foreign Application Priority Data
Dec. 22, 2016 (KR) 10-2016-0177106
Dec. 20, 2017 (KR) 10-2017-0175847

(51) Int. Cl. G06Q 10/10; H04L 12/58; G06F 3/0483

(52) U.S. Cl. CPC G06Q 10/1095; G06F 3/0483; H04L 51/04

(57) ABSTRACT

According to one aspect of the invention, there is provided a method for assisting schedule management, comprising the steps of: receiving an invitation e-mail transmitted from a host who intends to create an event to a guest who is invited to the event; and creating the event attended by the host and the guest, with reference to e-mail addresses and contents included in the invitation e-mail.

### FIELD OF THE INVENTION

The present invention relates to a method, system, and non-transitory computer-readable recording medium for assisting schedule management.

### BACKGROUND

In order to create a new event in a conventional calendar program (or application), a user should personally find an empty time slot in a time table, and manually enter specific information on the event one by one, such as a to-do item, location, start time, end time, recurrence, and notification time before the event. Therefore, a problem occurs in that the user should take much time and effort to manage a schedule. Although a variety of calendar programs are developed recently, those calendar programs simply differ in terms of exterior elements such as designs or titles, and basically have the same problem as above.

Further, a conventional calendar program may only provide schedule management functionality for a single user, and thus, when managing an event in which two or more users are involved, the users cannot avoid the inconvenience of personally contacting each other separately from the calendar program to discuss about the time or location of the event, and entering information on the determined time or location of the event into the calendar program, one by one.

Meanwhile, in order to address the above problem of conventional calendar programs, there have been introduced programs for assisting convenient management of to-do lists. Such a to-do list management program may function to allow a user to conveniently enter and list his/her to-do items and to check the completion of the to-do items, but cannot give consideration to the duration of each to-do item or other events included in the user's schedule. Thus, the program has a limitation in that it is difficult to generally manage the user's schedule using the program.

In this connection, the inventor(s) present a technique for assisting in easily creating an event that two or more users attend together using e-mail.

### SUMMARY OF THE INVENTION

One object of the present invention is to solve all the above-described problems in the prior art.

Another object of the invention is to assist in easily creating an event that two or more users attend together using e-mail, by receiving an invitation e-mail transmitted from a host who intends to create an event to a guest who is invited to the event; and creating the event attended by the host and the guest, with reference to e-mail addresses and contents included in the invitation e-mail.

The representative configurations of the invention to achieve the above objects are described below.

According to one aspect of the invention, there is provided a method for assisting schedule management, comprising the steps of: receiving an invitation e-mail transmitted from a host who intends to create an event to a guest who is invited to the event; and creating the event attended by the host and the guest, with reference to e-mail addresses and contents included in the invitation e-mail.

According to another aspect of the invention, there is provided a system for assisting schedule management, comprising: an e-mail management unit configured to receive an invitation e-mail transmitted from a host who intends to create an event to a guest who is invited to the event; and an event management unit configured to create the event attended by the host and the guest, with reference to e-mail addresses and contents included in the invitation e-mail.

In addition, there are further provided other methods and systems to implement the invention, as well as non-transitory computer-readable recording media having stored thereon computer programs for executing the methods.

According to the invention, an event may be easily created without going through a cumbersome process in which a plurality of users coordinate their opinions before creating the event, because a user may just send a simple e-mail to other users so that an event attended by all of a plurality of users who send and receive the e-mail is created in their schedules.

According to the invention, users who are using different types of schedule management services may also easily and quickly create an event that the users attend together.

According to the invention, a plurality of users to attend an event may easily coordinate details of the event through e-mail.

### BRIEF DESCRIPTION OF THE DRAWINGS

FIG. 1 schematically shows the configuration of an entire system for assisting schedule management according to one embodiment of the invention.

FIG. 2 illustratively shows the internal configuration of a schedule management system according to one embodiment of the invention.

FIG. 3 illustratively shows contents of an invitation e-mail sent by a host who intends to create an event according to one embodiment of the invention.

FIG. 4 illustratively shows a situation in which an invitation e-mail sent by a host is transmitted according to one embodiment of the invention.

FIG. 5 illustratively shows contents of a notice e-mail sent by the schedule management system according to one embodiment of the invention.

FIG. 6 illustratively shows a user interface provided by the schedule management system according to one embodiment of the invention.

FIG. 7 illustratively shows a situation in which a notice e-mail sent by the schedule management system is transmitted according to one embodiment of the invention.

FIG. 8 illustratively shows a situation in which a user's preference information on details of an event is inputted through a user interface provided by the schedule management system according to one embodiment of the invention.

FIGS. 9 and 10 illustratively show a situation in which details of an event are coordinated between a host and guests who will attend the event according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of the Entire System

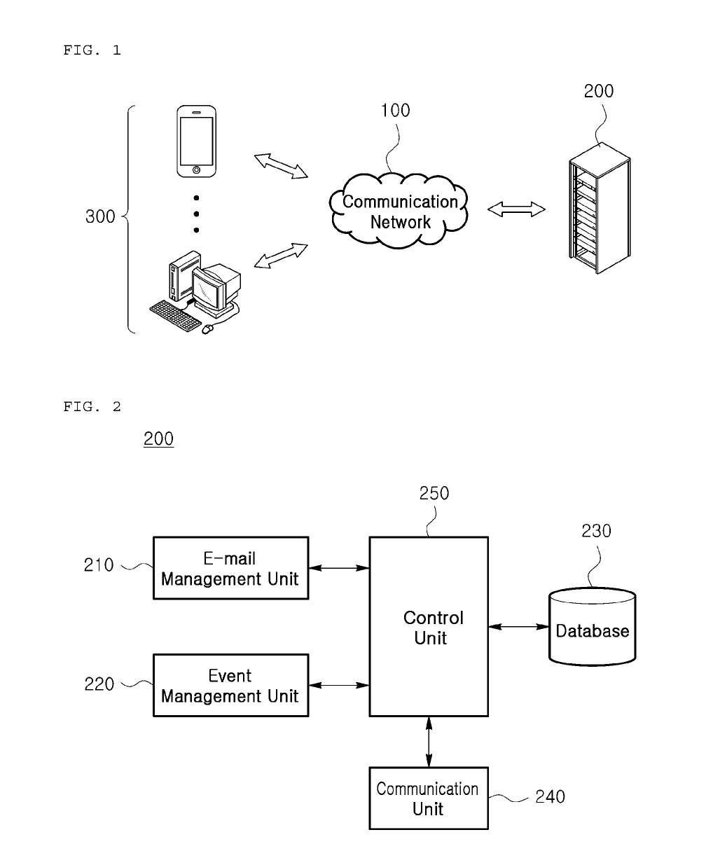

FIG. 1 schematically shows the configuration of the entire system for assisting schedule management according to one embodiment of the invention.

As shown in FIG. 1, the entire system according to one embodiment of the invention may comprise a communication network 100, a schedule management system 200, and a user device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

Next, the schedule management system 200 according to one embodiment of the invention may function to assist in easily creating an event that two or more users attend together using e-mail, by receiving an invitation e-mail transmitted from a host who intends to create an event to a guest who is invited to the event; and creating the event that the host and the guest attend together, with reference to e-mail addresses and contents included in the invitation e-mail.

The configuration and function of the schedule management system 200 according to the invention will be discussed in more detail below.

Next, according to one embodiment of the invention, the user device 300 is digital equipment that may function to allow a user who intends to create an event (i.e., a host) or a user who is invited to the event (i.e., a guest) to communicate with the schedule management system 200 and a known e-mail server (not shown), and any type of digital equipment having a memory means and a microprocessor for computing capabilities, such as a smart phone, a tablet, a desktop computer, a notebook computer, a workstation, a personal digital assistant (PDA), a web pad, and a mobile phone, may be adopted as the user device 300 according to the invention.

Particularly, the user device 300 may include an application (not shown) to assist a user to receive services from the schedule management system 200. The application may be downloaded from the schedule management system 200 or a known web server (not shown). It is apparent that the application may be provided by implementing a calendar GUI of a conventional calendar program (e.g., a calendar GUI for schedule management in Microsoft Outlook), as necessary. At least a part of information for constructing the calendar GUI may be received from the schedule management system 200.

Configuration of the Schedule Management System

Hereinafter, the internal configuration of the schedule management system 200 crucial for implementing the invention and the functions of the respective components thereof will be discussed.

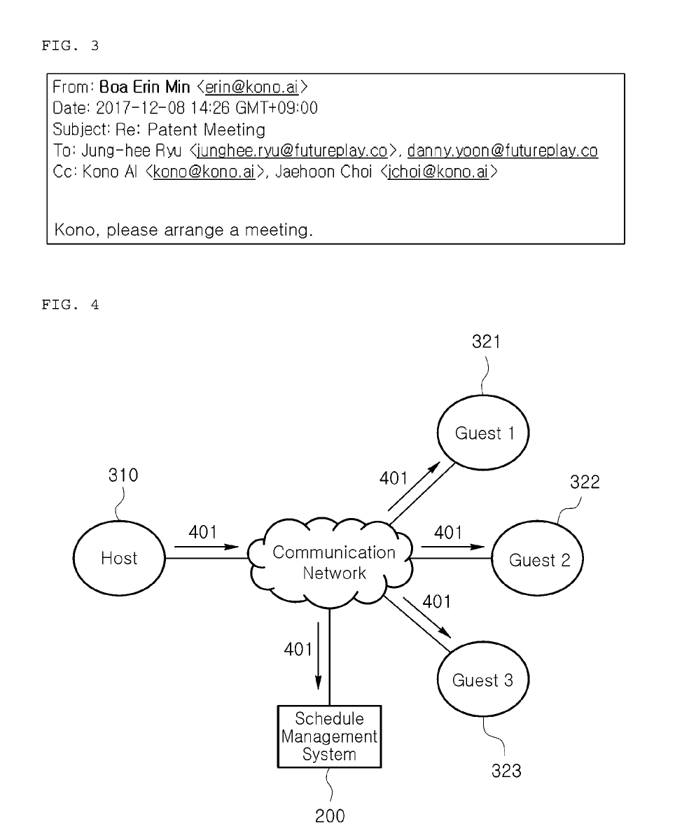

FIG. 2 illustratively shows the internal configuration of the schedule management system according to one embodiment of the invention.

Referring to FIG. 2, the schedule management system 200 according to one embodiment of the invention may comprise an e-mail management unit 210, an event management unit 220, a database 230, a communication unit 240, and a control unit 250. According to one embodiment of the invention, at least some of the e-mail management unit 210, the event management unit 220, the database 230, the communication unit 240, and the control unit 250 may be program modules to communicate with an external system (not shown). The program modules may be included in the schedule management system 200 in the form of operating systems, application program modules, and other program modules, while they may be physically stored in a variety of commonly known storage devices. Further, the program modules may also be stored in a remote storage device that may communicate with the schedule management system 200. Meanwhile, such program modules may include, but not limited to, routines, subroutines, programs, objects, components, data structures and the like for performing specific tasks or executing specific abstract data types as will be described below in accordance with the invention.

First, according to one embodiment of the invention, the e-mail management unit 210 may function to receive an invitation e-mail transmitted from a host who intends to create an event to a guest who is invited to the event. According to one embodiment of the invention, a plurality of guests may be invited to the event.

Specifically, according to one embodiment of the invention, when sending the invitation e-mail to the guest, the host may enter an e-mail address of the schedule management system 200 according to one embodiment of the invention in the To, Cc, or Bcc field of the invitation e-mail, so that the schedule management system 200 according to one embodiment of the invention may receive the invitation e-mail.

Next, according to one embodiment of the invention, the event management unit 220 may function to create an event attended by at least one of the host and the guest, with reference to e-mail addresses and contents included in the received invitation e-mail. That is, the event management unit 220 according to one embodiment of the invention may recognize that the host intends to create an event to attend together with the guest, by interpreting the invitation e-mail that the host sends to create the event, and may autonomously create the event that the host and the guest attend together according to the recognition, and add the created event to the respective schedules of the host and the guest.

Here, according to one embodiment of the invention, a known artificial intelligence algorithm may be used when the event management unit 220 interprets the received invitation e-mail and creates the event. It is noted that various artificial intelligence algorithms may be used without being limited to any specific artificial intelligence algorithm, as long as the objects of the invention may be achieved.

Further, according to one embodiment of the invention, the event management unit 220 may provide the host and the guest with a user interface for assisting in inputting preference information on details of the event, thereby assisting the host and the guest to directly determine the details of the event through coordination therebetween.

Further, according to one embodiment of the invention, the event management unit 220 may transmit the preference information inputted from any one user of the host and the guest to the other user, thereby encouraging all users who will attend the event to participate in the coordination process for determining the details of the event (so-called peer pressure).

Further, according to one embodiment of the invention, when the preference information on a first detail of the event inputted by the host and the guest coincides or converges at or above a predetermined level between the host and the guest, the event management unit 220 may determine the first detail of the event according to the preference information that coincides or converges at or above the predetermined level.

Further, according to one embodiment of the invention, when mandatory details (e.g., a time) of the event are not determined over a predetermined time, the event management unit 220 may again provide the host and the guest with a user interface for assisting in inputting the preference information on the mandatory details.

Here, according to one embodiment of the invention, the details of the event may include, but not necessarily limited to, attendance at or absence from the event, a time of the event, and a location of the event, and may be changed without limitation as long as the objects of the invention may be achieved. Further, according to one embodiment of the invention, the provision of the user interfaces and the transmission of the preference information as mentioned above may be carried out through e-mail.

For example, the user interfaces provided to the users (i.e., the host and the guest) may assist the users to make a selection of any one of preference and non-preference for some candidate times proposed as the time of the event (i.e., an alternate choice), or to make a selection of any one of preference, neutrality, and non-preference therefor (i.e., a threefold choice). More specifically, according to one embodiment of the invention, the user interfaces may include a GUI for assisting the users to input a simple selection operation such as a touch or click for each candidate time to adjust the users' preference therefor. The GUI may allow a display state (e.g., color, shade, border, size, etc.) of each candidate time to be changed according to the users' preference state therefor.

As another example, the user interfaces provided to the users may assist the users to further input the preference information on the location of the event. Further, according to one embodiment of the invention, the user interfaces may include a GUI for assisting the users to directly specify a preferred location on an electronic map.

Meanwhile, according to another embodiment of the invention, the event management unit 220 may autonomously determine the details of the event with reference to context information on the schedules of the host and the guest, rather than assist the host and the guest to directly determine the details of the event through the coordination therebetween as described above. For example, the event management unit 220 according to one embodiment of the invention may determine, as the time of the event, a time judged to be suitable for holding the event in the respective schedules of the host and the guest.

Here, according to one embodiment of the invention, the context information on the schedules may include information on empty time periods within the schedule of the user (i.e., the guest or the host); information on a title, a time, a location, or other attending users of another event existing before or after an empty time period within the user's schedule; demographic information of the user; information on times preferred by the user; information on locations preferred by the user; information on the user's activities on a social network service (SNS); information on chats that the user has had with other users; information on the user's to-do list; information on memos created by the user; information on a history of the user's event implementation; and information on a time, a location, or attributes of an event that the user intends to create. However, it is noted that the context information described herein is not necessarily limited to the foregoing, and any other information may be used as the context information, as long as the objects of the invention may be achieved.

Further, according to another embodiment of the invention, a known artificial intelligence algorithm may be used when the event management unit 220 autonomously determines the details of the event with reference to the context information on the schedules of the host and the guest. It is noted that various artificial intelligence algorithms may be used without being limited to any specific artificial intelligence algorithm, as long as the objects of the invention may be achieved.

Meanwhile, the database 230 according to one embodiment of the invention may store the context information on the schedules of the users (i.e., the host or the guest). Although FIG. 2 shows that the database 230 is incorporated in the schedule management system 200, the database 230 may be configured separately from the schedule management system 200 as needed by those skilled in the art to implement the invention. Meanwhile, the database 230 according to the invention encompasses a computer-readable recording medium, and may refer not only to a database in a narrow sense but also to a database in a broad sense including file system-based data records and the like. The database 230 according to the invention may be even a collection of simple logs if one can search and retrieve data from the collection.

Meanwhile, the communication unit 240 according to one embodiment of the invention may function to enable the schedule management system 200 to communicate with an external device such as the user device 300.

Lastly, the control unit 250 according to one embodiment of the invention may function to control data flow among the e-mail management unit 210, the event management unit 220, the database 230, and the communication unit 240. That is, the control unit 250 may control inbound data flow or data flow among the respective components of the schedule management system 200, such that the e-mail management unit 210, the event management unit 220, the database 230, and the communication unit 240 may carry out their particular functions, respectively.

### Embodiments

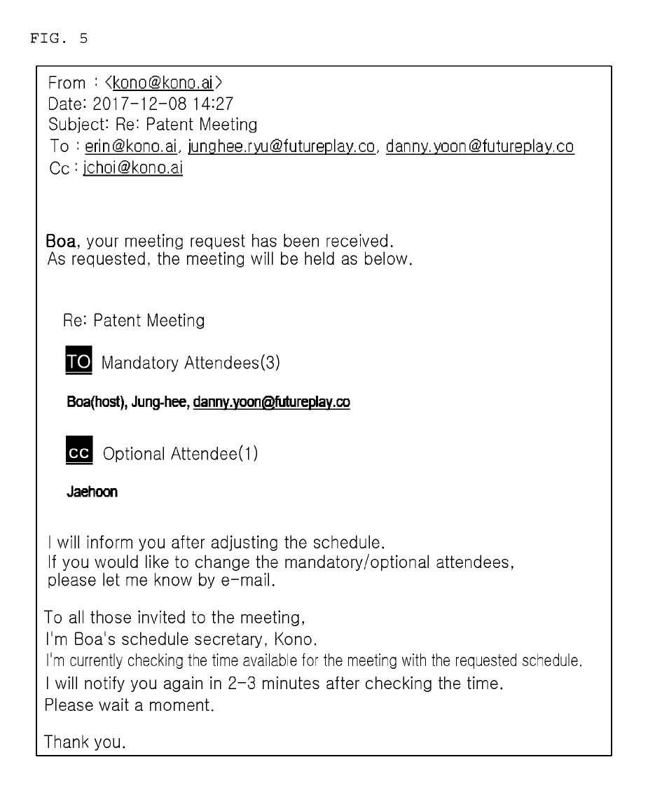

Hereinafter, the embodiments for assisting in creating an event attended by a plurality of users through e-mail according to the invention will be discussed in detail with reference to FIGS. 3 to 10.

First, FIG. 3 illustratively shows contents of an invitation e-mail sent by a host who intends to create an event according to one embodiment of the invention.

Referring to FIG. 3, a host who intends to create an event (i.e., “erin@kono.ai”) may send an e-mail saying “Kono, please arrange a meeting.” to three guests who are invited to the event (i.e., “junghee.ryu@futureplay.co”, “danny.yoon@futureplay.co” and “jchoi@kono.ai”) and Kono AI (i.e., “kono@kono.ai”), which is the schedule management system 200 according to the invention.

Next, FIG. 4 illustratively shows a situation in which an invitation e-mail sent by a host is transmitted according to one embodiment of the invention.

Referring to FIG. 4, an invitation e-mail sent by a host 310 may be transmitted to three guests 321, 322, 323 and the schedule management system 200 (401).

Next, FIG. 5 illustratively shows contents of a notice e-mail sent by the schedule management system according to one embodiment of the invention.

Referring to FIG. 5, the schedule management system 200 according to one embodiment of the invention may recognize that the host 310 intends to create a meeting event to attend together with the three guests 321, 322, 323, with reference to the e-mail addresses included in the invitation e-mail received from the host 310 and the contents of the e-mail (i.e., “Kono, please arrange a meeting.”), and may create the meeting event that the host 310 and the three guests 321, 322, 323 attend together according to the recognition, and send a notice e-mail regarding the created meeting event to the host 310 and the three guests 321, 322, 323. According to one embodiment of the invention, the host, “erin@kono.ai” and the guests, “junghee.ryu@futureplay.co” and “danny.yoon@futureplay.co” may be classified as mandatory attendees who must attend the meeting event, and the guest, “jchoi@kono.ai” may be classified as an optional attendee who may optionally attend the meeting event, considering that the guests, “junghee.ryu@futureplay.co” and “danny.yoon@futureplay.co” are included in the To field and the guest, “jchoi@kono.ai” is included in the Cc field in the invitation e-mail of FIG. 3.

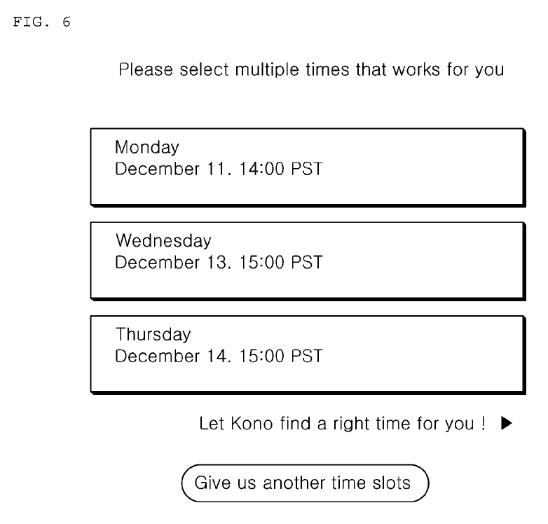

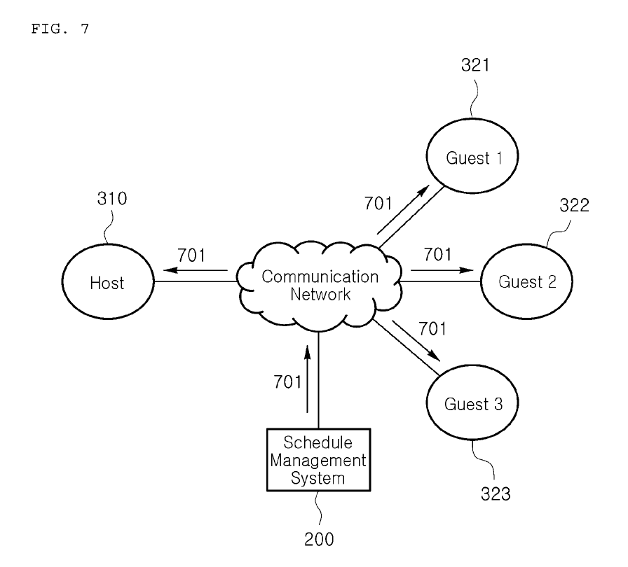

Next, FIG. 6 illustratively shows a user interface provided by the schedule management system according to one embodiment of the invention.

Referring to FIG. 6, the schedule management system 200 according to one embodiment of the invention may provide the host 310 and the three guests 321, 322, 323 with a user interface for assisting in inputting preference information on a time of the meeting event created as above, in order to determine the time of the meeting event. For example, the host 310 and the three guests 321, 322, 323 may select a time preferred for the time of the meeting event, among three candidate times proposed through the user interface (i.e., December 11 (Monday), 14:00, December 13 (Wednesday), 15:00, and December 14 (Thursday), 15:00).

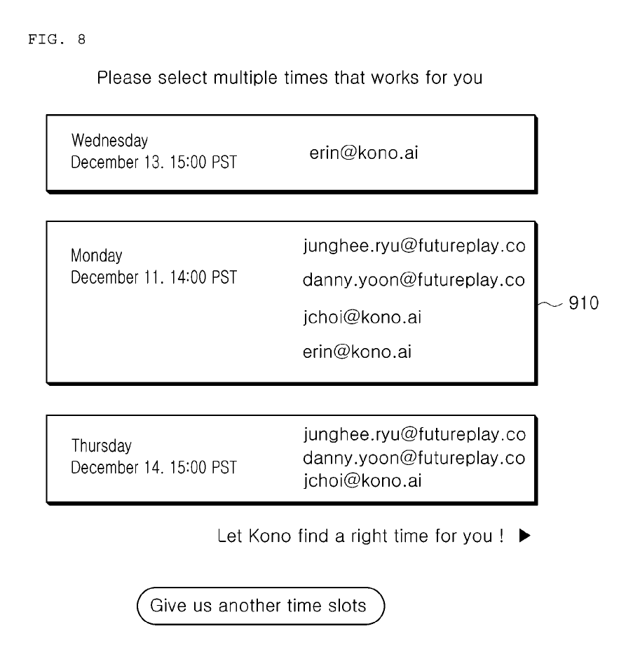

FIG. 7 illustratively shows a situation in which a notice e-mail sent by the schedule management system is transmitted according to one embodiment of the invention.

Referring to FIG. 7, the notice e-mail of FIG. 5 sent by the schedule management system may be transmitted to all the attendees (i.e., the host 310 and the three guests 321, 322, 323) (701). The user interface provided by the schedule management system may also be transmitted to all the attendees (i.e., the host 310 and the three guests 321, 322, 323) in the form of an e-mail (701).

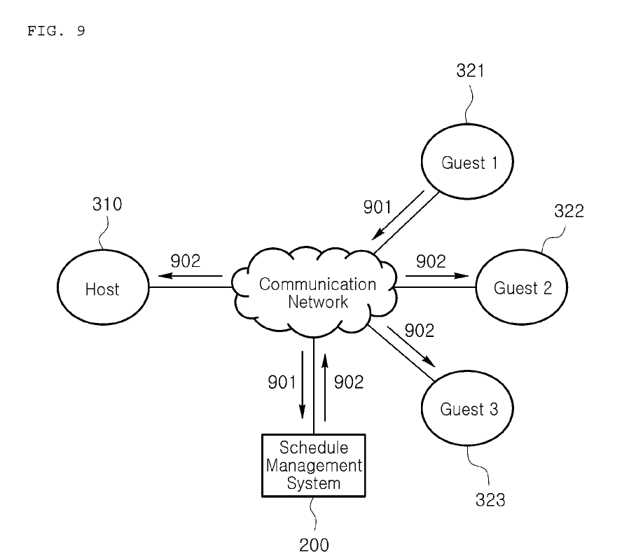

FIG. 8 illustratively shows a situation in which a user's preference information on details of the event is inputted through a user interface provided by the schedule management system according to one embodiment of the invention.

Referring to FIG. 8, when the preference information on the time of the meeting event inputted through the user interface coincides or converges at or above a predetermined level between all the attendees, the time of the meeting event may be determined according to the preference information that coincides or converges at or above the predetermined level. In the embodiment of FIG. 8, the candidate times may be highlighted according to the degrees of preference of the attendees (i.e., the numbers of times of selection by the attendees), and December 11 (Monday), 14:00, which is most preferred by the attendees, may be determined as the time of the meeting event.

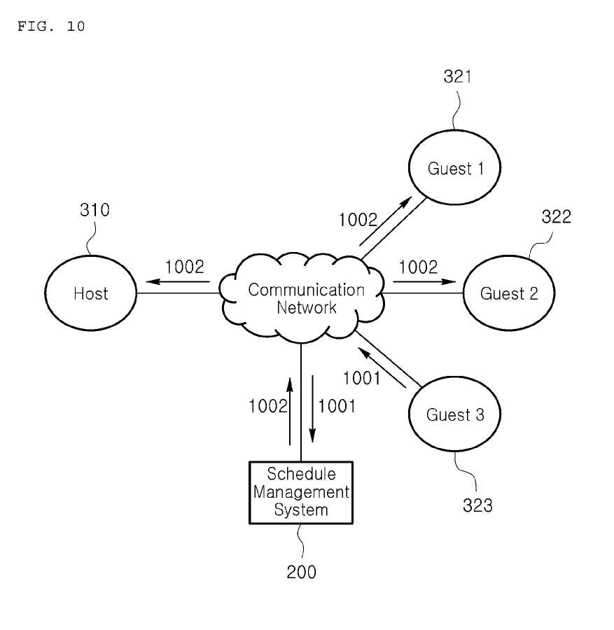

FIGS. 9 and 10 illustratively show a situation in which details of the event are coordinated between the host and the guests who will attend the event according to one embodiment of the invention.

Referring to FIG. 9, when the first guest 321 inputs preference information on the time of the meeting event, the inputted preference information may be transmitted to the schedule management system 200 (901). The schedule management system 200 may transmit the preference information inputted by the first guest 321 to the rest of the attendees, i.e., the host 310, the second guest 322, and the third guest 323 (902). Accordingly, the attendees except the first guest 321 who has inputted the preference information may come under peer pressure to input preference information on the time of the meeting event with reference to the preference information inputted by the first guest 321, which may facilitate the process of determining the time of the meeting event through the coordination between all the attendees.

Referring to FIG. 10, when the third guest 323 who is the optional attendee inputs preference information indicating that he/she will not attend the meeting event, as the preference information on attendance at or absence from the meeting event, the inputted preference information may be transmitted to the schedule management system 200 (1001). The schedule management system 200 may transmit the information on the absence of the third guest 323 to the rest of the attendees, i.e., the host 310, the first guest 321, and the second guest 322 (1002).

Further, referring to FIG. 10, when it is confirmed that the third guest 323 will not attend the meeting event, the process in which the attendees except the third guest 323 (i.e., the host 310, the first guest 321, and the second guest 322) input the preference information on the time of the meeting event through the user interfaces, may be carried out again from the beginning.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for assisting schedule management, comprising the steps of:
receiving an invitation e-mail transmitted from a host who intends to create an event to a guest who is invited to the event; and
creating the event attended by the host and the guest, with reference to e-mail addresses and contents included in the invitation e-mail.

2. The method of claim 1, further comprising the steps of:
providing the host and the guest with a user interface for assisting in inputting preference information on details of the event; and
transmitting the preference information inputted from any one user of the host and the guest to the other user.

3. The method of claim 2, wherein the user interface and the preference information are provided or transmitted through e-mail.

4. The method of claim 2, wherein the details include at least one of attendance at or absence from the event, a time of the event, and a location of the event.

5. The method of claim 2, wherein when the preference information on a first detail of the event inputted by the host and the guest coincides or converges at or above a predetermined level between the host and the guest, the first detail of the event is determined according to the preference information that coincides or converges at or above the predetermined level.

6. The method of claim 2, wherein when mandatory details of the event are not determined over a predetermined time, the host and the guest are again provided with a user interface for assisting in inputting the preference information on the mandatory details.

7. The method of claim 1, further comprising the step of:
determining at least a part of details of the event, with reference to context information on schedules of the host and the guest.

8. A non-transitory computer-readable recording medium having stored thereon a computer program for executing the method of claim 1.

9. A system for assisting schedule management, comprising:
an e-mail management unit configured to receive an invitation e-mail transmitted from a host who intends to create an event to a guest who is invited to the event; and
an event management unit configured to create the event attended by the host and the guest, with reference to e-mail addresses and contents included in the invitation e-mail.

10. The system of claim 9, wherein the event management unit provides the host and the guest with a user interface for assisting in inputting preference information on details of the event, and transmits the preference information inputted from any one user of the host and the guest to the other user.

11. The system of claim 10, wherein the user interface and the preference information are provided or transmitted through e-mail.

12. The system of claim 10, wherein the details include at least one of attendance at or absence from the event, a time of the event, and a location of the event.

13. The system of claim 10, wherein when the preference information on a first detail of the event inputted by the host and the guest coincides or converges at or above a predetermined level between the host and the guest, the event management unit determines the first detail of the event according to the preference information that coincides or converges at or above the predetermined level.

14. The system of claim 10, wherein when mandatory details of the event are not determined over a predetermined time, the event management unit again provides the host and the guest with a user interface for assisting in inputting the preference information on the mandatory details.

15. The system of claim 9, wherein the event management unit determines at least a part of details of the event, with reference to context information on schedules of the host and the guest.
